(19) United States
(12) Patent Application Publication
(10) Pub. No.: US 2011/0064289 A1
(43) Pub. Date: Mar. 17, 2011

(54) Systems and Methods for Multilevel Nodule Attachment Classification in 3D CT Lung Images

(75) Inventors: Jinbo Bi, Chester Springs, PA (US); Le Lu, Chalfont, PA (US); Marcos Salganicoff, Bala Cynwyd, PA (US); Yoshihisa Shinagawa, Downingtown, PA (US); Dijia Wu, North Brunswick, NJ (US)

(73) Assignee: Siemens Medical Solutions USA, Inc., Malvern, PA (US)

(21) Appl. No.: 12/880,385

(22) Filed: Sep. 13, 2010

Related U.S. Application Data
(60) Provisional application No. 61/242,020, filed on Sep. 14, 2009.

(51) Int. Cl. G06K 9/62

(52) U.S. Cl. 382/128

(57) ABSTRACT

Automated and semi-automated systems and methods for detection and classification of structures within 3D lung CT images using voxel-level segmentation and subvolume-level classification.

### CROSS-REFERENCE TO RELATED APPLICATION

The present application is a utility patent application, which claims the benefit of U.S. Provisional Application No. 61/242,020, filed Sep. 14, 2009, which is hereby incorporated herein by reference in its entirety.

### TECHNICAL FIELD

The present disclosure relates to computer aided detection in medical image analysis and, more specifically, to automated or semi-automated systems and methods for analyzing and classifying detected structures in 3D medical images, particularly nodules detected in images of the lungs.

### BACKGROUND

The field of medical imaging has seen significant advances since the time X-Rays were first used to determine anatomical abnormalities. Medical imaging hardware has progressed in the form of newer machines such as Medical Resonance Imaging (MRI) scanners, Computed Axial Tomography (CAT) scanners, etc. Because of large amount of image data generated by such modern medical scanners, there has been and remains a need for developing image processing techniques that can automate some or all of the processes to determine the presence of anatomical abnormalities in scanned medical images.

Recognizing anatomical structures within digitized medical images presents multiple challenges. For example, a first concern relates to the accuracy of recognition of anatomical structures within an image. A second area of concern is the speed of recognition. Because medical images are an aid for a doctor to diagnose a disease or condition, the speed with which an image can be processed and structures within that image recognized can be of the utmost importance to the doctor reaching an early diagnosis. Hence, there is a need for improving recognition techniques that provide accurate and fast recognition of anatomical structures and possible abnormalities in medical images.

Digital medical images are constructed using raw image data obtained from a scanner, for example, a CAT scanner, MRI, etc. Digital medical images are typically either a two-dimensional (“2-D”) image made of pixel elements or a three-dimensional (“3-D”) image made of volume elements (“voxels”). Such 2-D or 3-D images are processed using medical image recognition techniques to determine the presence of anatomical structures such as cysts, tumors, polyps, etc. Given the amount of image data generated by any given image scan; it is preferable that an automatic technique should point out anatomical features in the selected regions of an image to a doctor for further diagnosis of any disease or condition.

One general method of automatic image processing employs feature based recognition techniques to determine the presence of anatomical structures in medical images. However, feature based recognition techniques can suffer from accuracy problems.

Automatic image processing and recognition of structures within a medical image is generally referred to as Computer-Aided Detection (CAD). A CAD system can process medical images and identify anatomical structures including possible abnormalities for further review. Such possible abnormalities are often called candidates and are considered to be generated by the CAD system based upon the medical images.

One particularly common and important use for medical imaging systems and CAD systems is in review of lung images to detect and identify any potentially dangerous anatomical structures such as abnormal growths. In order to effectively review lung images, there are a number of different structures that the reviewer or reviewing CAD system must be able to detect and classify, including but not limited to, airways, fissures, nodules, vessels, pleura, and parenchyma.

Due to the various different types of structures and the wide spectrum of characteristics each structure may display, lung images are often not suitable for CAD review and require complete physician review. However, this can be extremely time consuming and can still be prone to error.

Therefore there is a need for improved automated or semi-automated systems and methods for review, detection, and classification of structures in lung images.

### SUMMARY OF THE INVENTION

A method for classification of anatomical structures in digital images is provided including acquiring at least one digital image, automatically detecting at least one anatomical structure in the digital image, automatically classifying the at least one anatomical structure by applying a voxel-level segmentation to the image and a subvolume level classification to the image.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings.

FIG. 1 shows exemplary images before and after application of filters according to exemplary embodiments of the present disclosure.

FIG. 2 is a table showing testing data for systems and methods according to the present disclosure.

FIG. 3 is a table showing testing data for systems and methods according to the present disclosure.

FIG. 4 shows exemplary segmentation results obtained using systems according to the present disclosure.

FIG. 5 shows exemplary segmentation results obtained using systems according to the present disclosure.

FIG. 6 shows exemplary segmentation results obtained using systems according to the present disclosure.

FIG. 7 shows exemplary segmentation results obtained using systems according to the present disclosure.

FIG. 8 shows exemplary segmentation results obtained using systems according to the present disclosure.

FIG. 9 shows exemplary segmentation results obtained using systems according to the present disclosure.

FIG. 10 shows exemplary segmentation results obtained using a fissure enhancement filter.

FIG. 11 shows exemplary segmentation results following application of a filter.

FIG. 12 shows exemplary segmentation results following application of alternate and additional filters.

FIG. 13 shows exemplary segmentation and classification results obtained using systems and methods according to the present disclosure.

FIG. 14 shows exemplary segmentation and classification results obtained using systems and methods according to the present disclosure.

FIG. 15 shows exemplary segmentation and classification results obtained using systems and methods according to the present disclosure.

FIG. 16 shows exemplary successful segmentation results obtained using systems and methods according to the present disclosure.

FIG. 17 shows an example of a computer system capable of implementing the method and apparatus according to embodiments of the present disclosure.

### DETAILED DESCRIPTION OF THE INVENTION

In the following description, numerous specific details are set forth such as examples of specific components, devices, methods, etc., in order to provide a thorough understanding of embodiments of the present invention. It will be apparent, however, to one skilled in the art that these specific details need not be employed to practice embodiments of the present invention. In other instances, well-known materials or methods have not been described in detail in order to avoid unnecessarily obscuring embodiments of the present invention. While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

The term “x-ray image” as used herein may mean a visible x-ray image (e.g., displayed on a video screen) or a digital representation of an x-ray image (e.g., a file corresponding to the pixel output of an x-ray detector). The term “in-treatment x-ray image” as used herein may refer to images captured at any point in time during a treatment delivery phase of a radiosurgery or radiotherapy procedure, which may include times when the radiation source is either on or off. From time to time, for convenience of description, CT imaging data may be used herein as an exemplary imaging modality. It will be appreciated, however, that data from any type of imaging modality including but not limited to X-Ray radiographs, MRI, CT, PET (positron emission tomography), PET-CT, SPECT, SPECT-CT, MR-PET, 3D ultrasound images or the like may also be used in various embodiments of the invention.

Unless stated otherwise as apparent from the following discussion, it will be appreciated that terms such as “segmenting,” “generating,” “registering,” “determining,” “aligning,” “positioning,” “processing,” “computing,” “selecting,” “estimating,” “detecting,” “tracking” or the like may refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices. Embodiments of the methods described herein may be implemented using computer software. If written in a programming language conforming to a recognized standard, sequences of instructions designed to implement the methods can be compiled for execution on a variety of hardware platforms and for interface to a variety of operating systems. In addition, embodiments of the present invention are not described with reference to any particular programming language. It will be appreciated that a variety of programming languages may be used to implement embodiments of the present invention.

As used herein, the term “image” refers to multi-dimensional data composed of discrete image elements (e.g., pixels for 2-D images and voxels for 3-D images). The image may be, for example, a medical image of a subject collected by computer tomography, magnetic resonance imaging, ultrasound, or any other medical imaging system known to one of skill in the art. The image may also be provided from non-medical contexts, such as, for example, remote sensing systems, electron microscopy, etc. Although an image can be thought of as a function from R³ to R or R⁷, the methods of the inventions are not limited to such images, and can be applied to images of any dimension, e.g., a 2-D picture or a 3-D volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

Exemplary embodiments of the present invention seek to provide an approach for automatically detecting, segmenting, and classifying structures within digital images of a patient's lungs.

In order to accurately classify a detected structure in the lung, it is important to obtain the contextual information for detected lung nodules and to determine if a detected lung nodule is solitary or connected.

According to aspects of the present disclosure, systems and methods are described for classifying lung nodules including segmentation of tissues including airways, fissures, nodules, vessels, pleura, and parenchyma, and subsequent subvolume-level classification of nodule connectivity.

Each different type of structure presents its own set of imaging and classification challenges. For example, fissures, when imaged generally appear having a low contrast surface and blurred or incomplete boundaries. Airways are often difficult to accurately image because of thin airway walls that can be discounted as imaging noise as well as the similar texture of small airways to lung parenchyma leading to a misclassification. Nodules are often visible in images but have an extremely wide variance in appearance and therefore can be difficult to classify. For example, nodules can appear to have spherical, ellipsoidal, speculate or other shapes and can have intensities in an image that are solid, partially solid, or GGO.

Prior systems and methods for automated or semi-automated review of lung images includes use of separate detection and classification systems and algorithms for each different type of lung structure. This allows for each system to be specialized for detection of a particular type of structure, but it also requires considerable computation and computing time because a series of different detection systems need to be run for each image.

According to one aspect of the present disclosure, a system is provided for segmentation and classification of lung tissues including fissures, airways, nodules, vessels, pleura, and parenchyma using a single classifier and a single feature set.

The systems and methods of the present disclosure can provide a simple and robust strategy for classification of lung structures while minimizing the details sacrificed. Systems and methods of the present disclosure include acquisition of digital images, analysis of the images to obtain sampling data, extraction of features from the digital image data including, but not limited to, intensity, texture, shape, etc. The systems and methods then include classification by application of a generative model and a discriminative model.

In order to analyze intensity data in the image data, the systems and methods of the present disclosure utilize Gaussian low-pass filtering, intensity statistics, and intensity histograms. Similarly, to analyze texture, the systems and methods of the present disclosure utilize LBP, wavelet analysis (Haar), and GLCM. Analysis of shape characteristics can include a hessian eigen-system based feature analysis.

The Hessian matrix eigenvalues include:

|K₃|≦|K₂|≦|K₁|

General shape characteristics are analyzed including ‘blob’ like features, ‘tube’ like features, and ‘plate’ like features. For blob features:

|K₁|≈|K₂|≈|K₃|>>0

For tube features:

|K₁|≈|K₂|>>|K₃|≈0

And for plate features:

|K₁|>>|K₂|≈|K₃|≈0

For each above described shape feature review, a filter is applied to enhance the image. For blob features, an exemplary filter is

$$( 1 - {e}^{\frac{{K}_{3}^{2}}{2 {α}^{2} \vert {K}_{1} {K}_{2} \vert}} ) ( 1 - {e}^{\frac{{K}_{1}^{2} + {K}_{2}^{2} + {K}_{3}^{2}}{2 {γ}^{2}}} )$$

For vessel or tube features, an exemplary filter is:

$$( 1 - {e}^{\frac{{K}_{2}^{2}}{2 {α}^{2} {K}_{1}^{2}}} ) {e}^{\frac{{K}_{3}^{2}}{2 {β}^{2} \vert {K}_{1} {K}_{2} \vert}} ( 1 - {e}^{\frac{{K}_{1}^{2} + {K}_{2}^{2} + {K}_{3}^{2}}{2 {γ}^{2}}} )$$

And for plate features, an exemplary filter is:

$${e}^{\frac{{K}_{2}^{2}}{2 {β}^{2} {K}_{1}^{2}}} ( 1 - {e}^{\frac{{K}_{1}^{2} + {K}_{2}^{2} + {K}_{3}^{2}}{2 {γ}^{2}}} )$$

The systems and methods of the present disclosure can include multiple scale filter response including, for example, 8 scales evenly spaced in range (e.g., 0.5, 4.0), where maximum response is extracted and ITK is implemented.

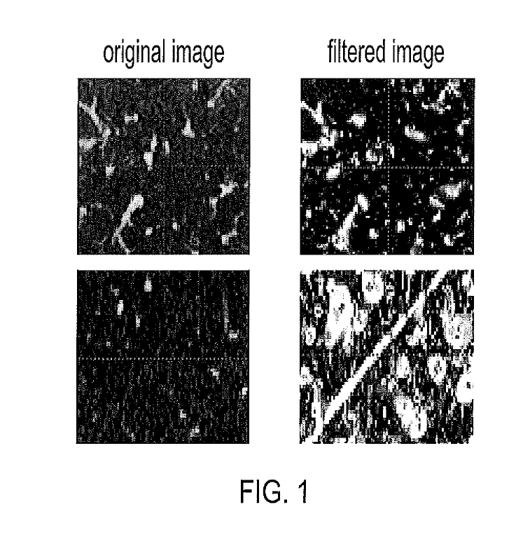

FIG. 1 shows an example of two original images (left) and the resulting images after application of the tube or vessel feature enhancement (top right) and the plate enhancement (bottom right) filters.

Systems and methods according to the present disclosure include application of a generative model classifier. One such exemplary classifier is the Resilient Subclass Discriminant Analysis (RSDA) which is a generative model and allows for analysis of multiple structural classes. The systems and methods additionally include application of a discriminative model classifier such as the Relevance Vector Machine (RVM) which is a discriminative model and which is a binary classifier.

### Results

Testing of exemplary systems and methods in accordance with the present disclosure included acquiring 34 subvolumes of image data. 17 of the subvolumes were assigned as training data and 17 were assigned as testing data.

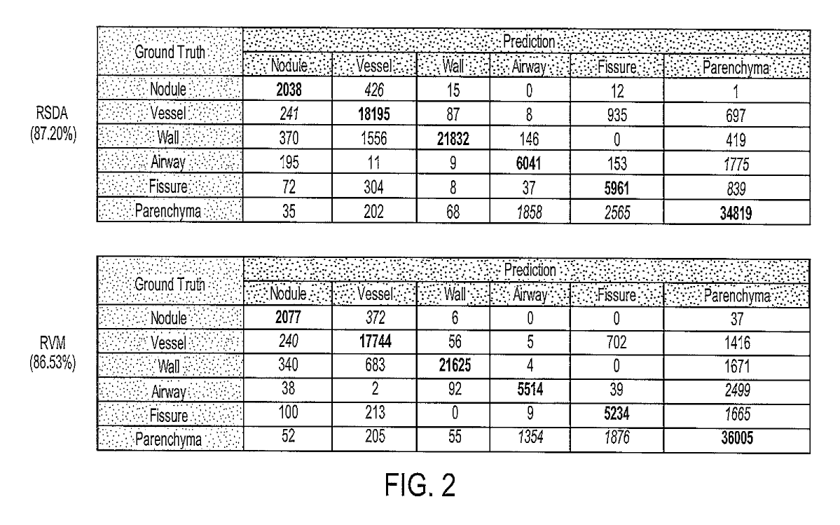

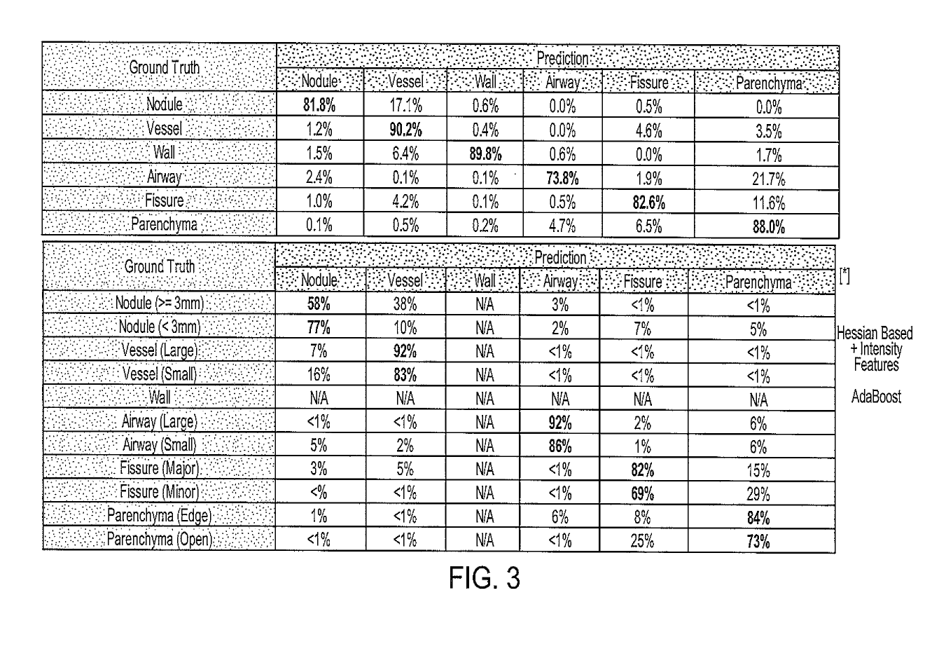

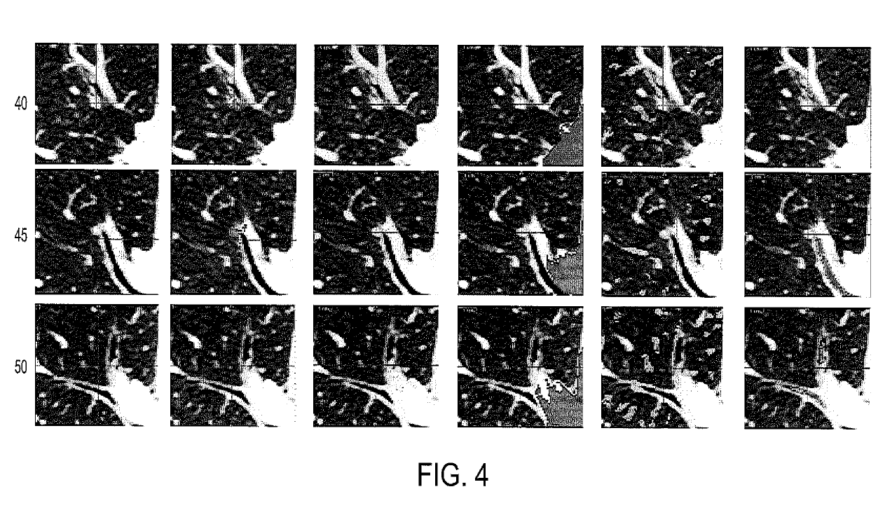

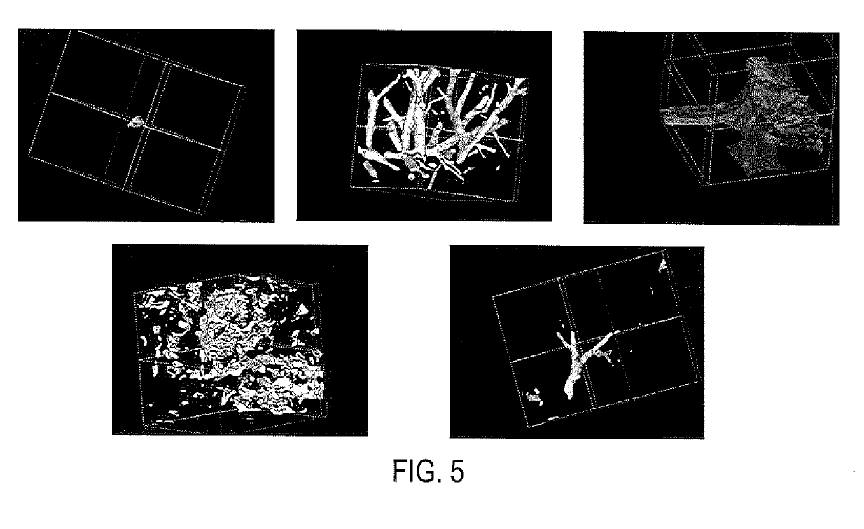

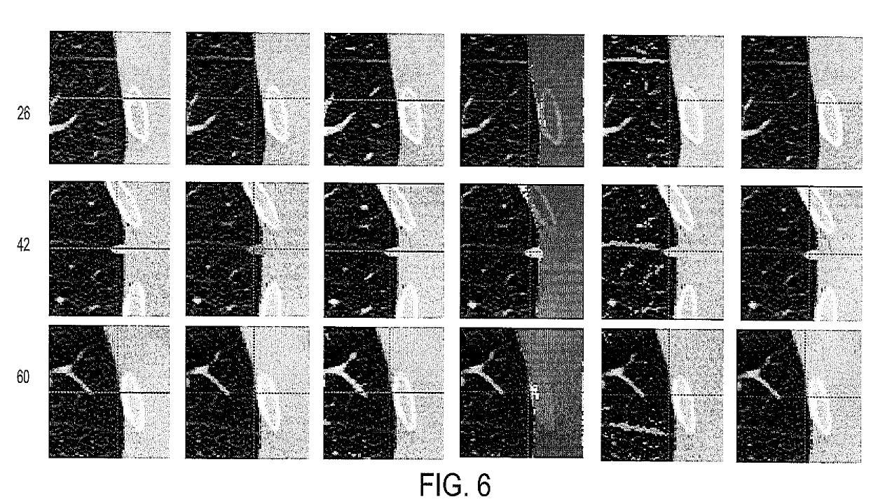

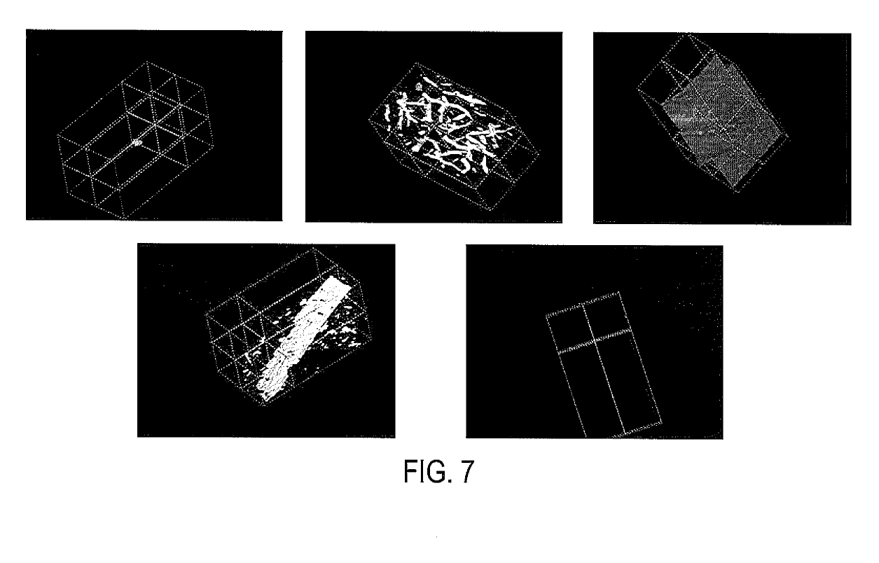

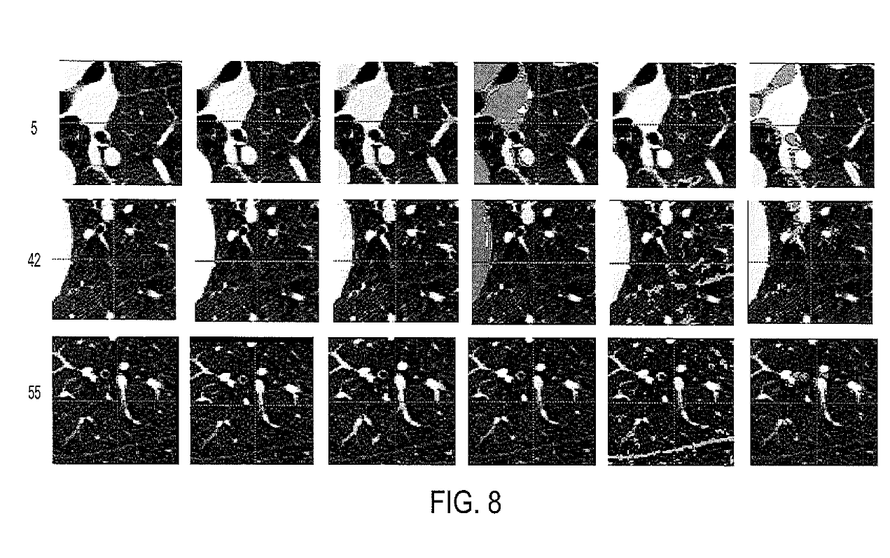

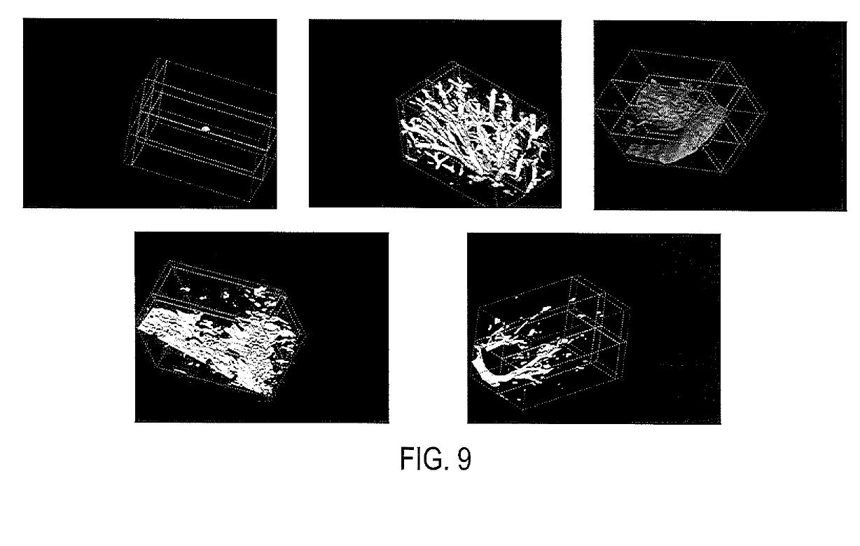

Testing results from application of the RSDA and RVM to the data can be seen in FIGS. 2 and 3. Additionally, segmentation results are shown in FIGS. 4-9.

As illustrated by the segmentation results shown in FIGS. 4-9, systems and methods in accordance with the present disclosure successfully segmented walls, vessels, airways and fissures. It was noted that walls and vessels were better segmented than airways and fissures due to inherent physical features of airways and fissures including that airways are not a dark vessel-like tube but appear as a thin bright airway wall. Multiple plate enhancement filter was not necessary to visualize fissures, rather anisotropic filtering is preferred.

According to aspects of the present disclosure, two rounds of voxel level data sampling are performed to determine boundary voxels for anatomical structures. Features for detected structures are extracted using, e.g., a Hessian eigen-system, and lower level classification is performed using RSDA and RVM.

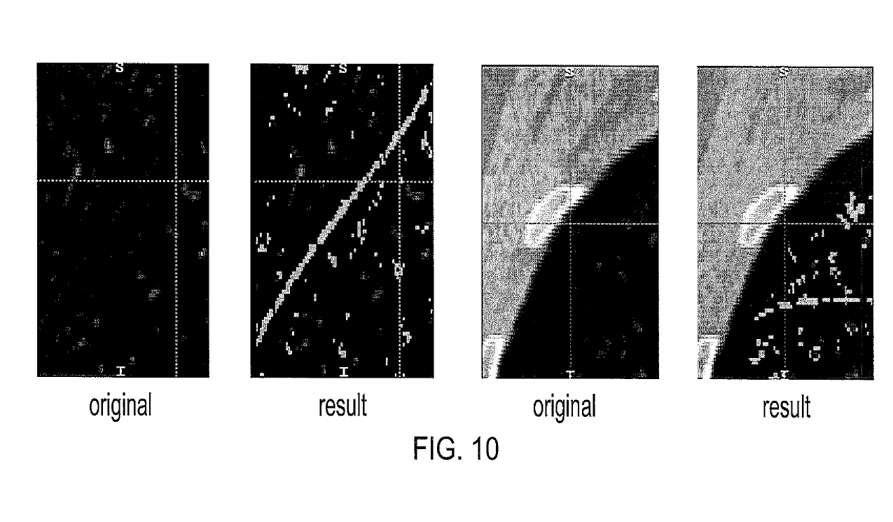

In order to better visualize fissures in image data, a fissure enhancement filter can be applied. Segmentation results using such a filter are shown in FIG. 10. The fissure enhancement filter can employ Hessian matrix eigenvalues of:

|K₃|≦|K₂|≦|K₁| |K₁|>>|K₂|≈|K₃|≈0

And the filter can be, for example,

$${e}^{\frac{{K}_{2}^{2}}{2 {β}^{2} {K}_{1}^{2}}} ( 1 - {e}^{\frac{{K}_{1}^{2} + {K}_{2}^{2} + {K}_{3}^{2}}{2 {γ}^{2}}} )$$

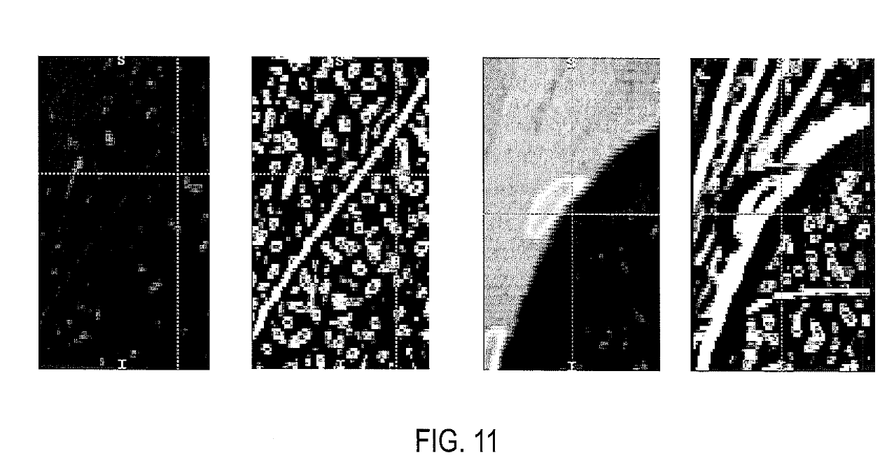

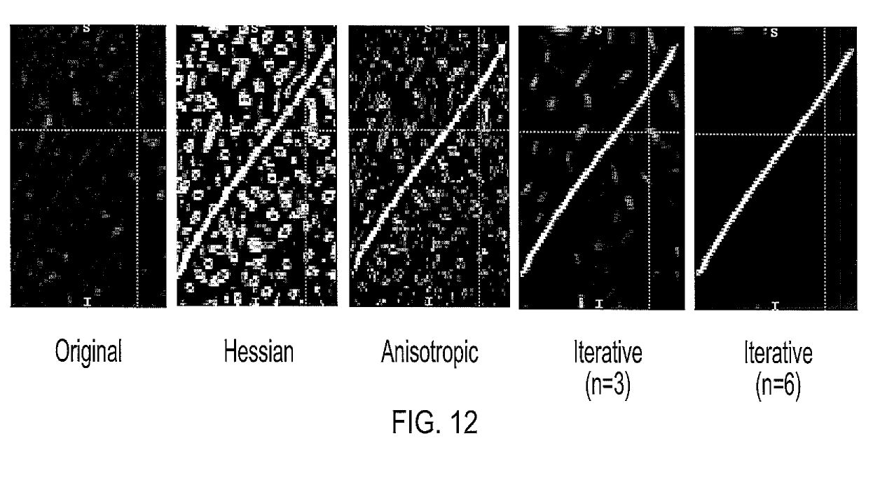

Another exemplary filter response is shown in FIG. 11. The systems and methods of the present disclosure can include anisotropic filtering where the leading eigenvector of Hessian matrix points to the normal direction of the plate surface. Such filtering can use smaller sigma along the normal direction and larger sigma along the tangent directions. Additionally, Iterative filtering can be used by iteratively applying the Hessian filter multiple times. Resulting filter responses are shown in FIG. 12.

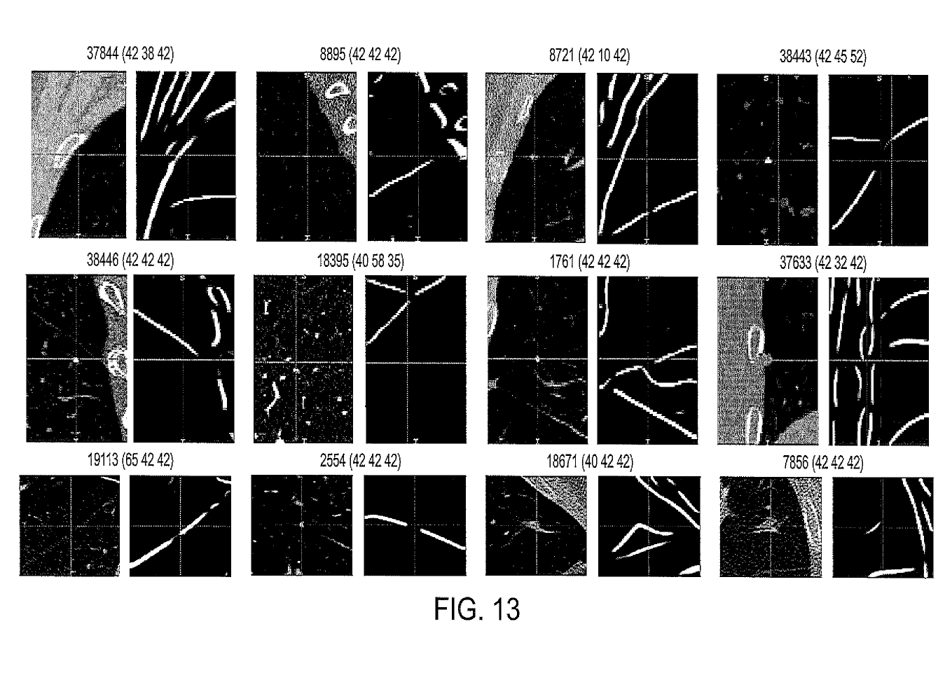

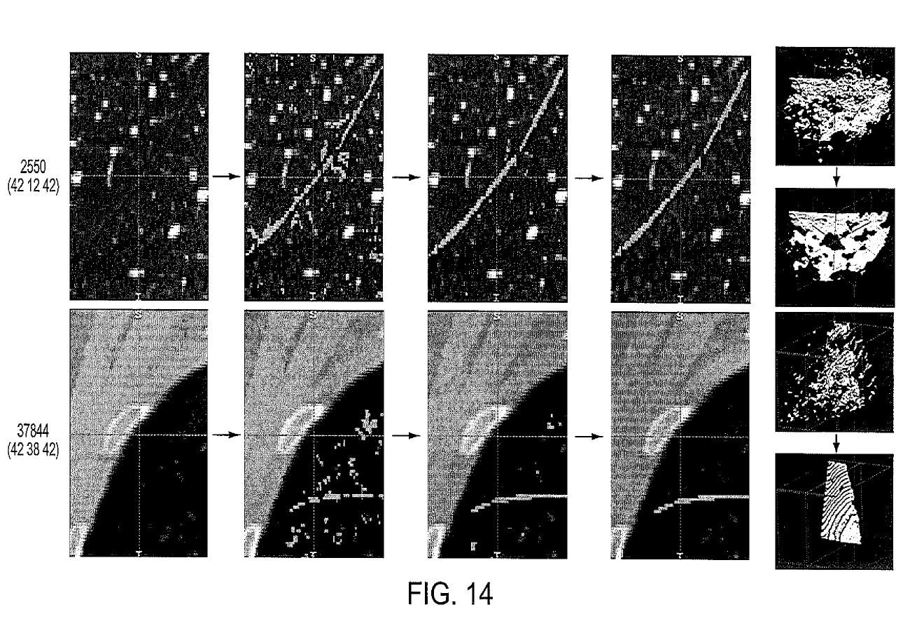

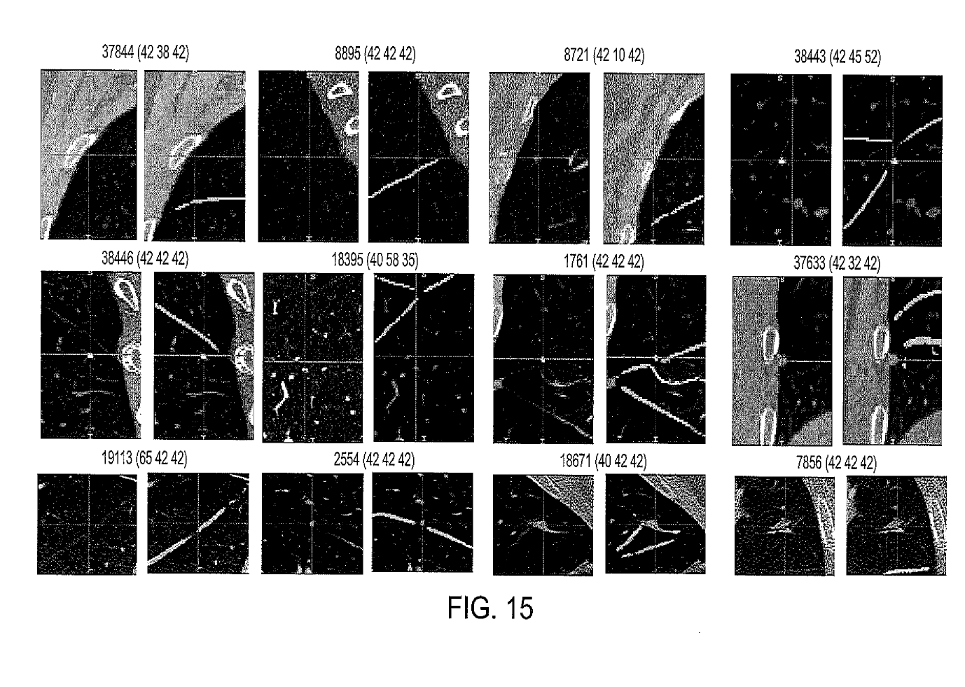

FIGS. 13-15 show exemplary classification results using systems and methods according to the present disclosure. Accurate segmentation of detected nodules is critical to higher level classification.

According to an aspect of the present disclosure, the following is an exemplary classifier:

$$- {\sum }_{i} log P ( {c}_{i} \vert x , i ) + μ {\sum }_{i , j ∈ {N}_{c}} {e}^{\frac{\vert {x}_{i} - {x}_{i} \vert}{β}} δ ( {c}_{i} \neq {c}_{j} )$$

The Unary term P(cᵢ|x,i) is normalized distribution given by the classifier.

The pairwise term allows for measuring the intensity difference between neighboring voxels, having the form of a contrast sensitive Potts model. Normalization parameter (beta) is important to accurate classification. In testing using the systems and methods of the present disclosure, each subvolume was classified in approximately 6 seconds and 712 out of 784 subvolumes tested were classified accurately.

One aspect of the present disclosure includes use of a statistical learning method to classify anatomical structures in image data. Use of such a method includes extracting features from soft probability map. The present disclosure includes correlating nodule probability map with each object (vessel, fissure, airway, wall, etc.) probability map. The correlation map will product higher responses where the detected nodule contacts the object with certain translation. If a nodule attaches to an object, higher responses should occur around the center of the correlation image. The method of the present disclosure includes generating circular surface around the center of the correlation image with a radius from 1 to 10, and calculating the sum and standard deviation of all responses on this surface.

The method of the present disclosure can include two sets of probability maps: an original probability map which includes image noise, and masked probability maps which are masked by the segmentation results which include nodule graph cut and small connected component removal.

In order to increase the accuracy of fissure detection and classification, the plate features of the correlation image are calculated as well as the distance to the origin of the nodule relative to its size:

x̅=Σᵢpᵢxᵢ/Σᵢpᵢ

y̅=Σᵢpᵢyᵢ/Σᵢpᵢ

z̅=Σᵢpᵢzᵢ/Σᵢpᵢ

W=Σᵢpᵢ[xᵢ− x̅,yᵢ− y̅,zᵢ z̅]·[xᵢ− x̅,yᵢ− y̅,zᵢ z̅]^{T}/Σᵢpᵢ

Wvᵢ=λᵢvᵢ (|λ₁|≦|λ₂|≦|λ₃|)

ω=e^{-|λ}^{₁}^{|/|λ}^{₂}^{|}

d=[ x̅, y̅, z̅]v₁

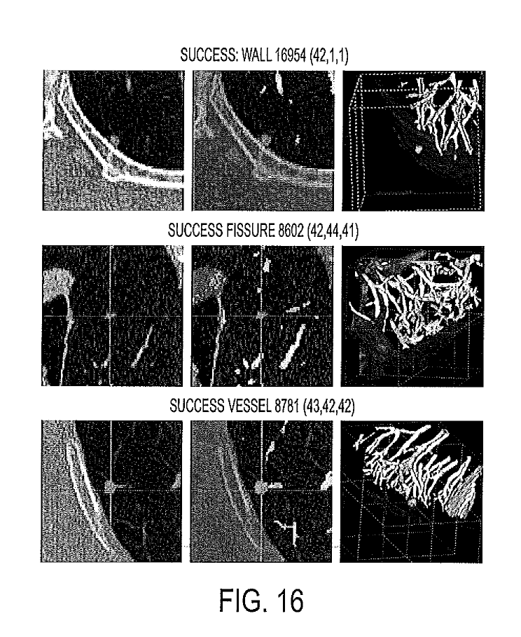

FIG. 16 shows exemplary successful segmentation results obtained using systems and methods according to the present disclosure.

### System Implementations

It is to be understood that embodiments of the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

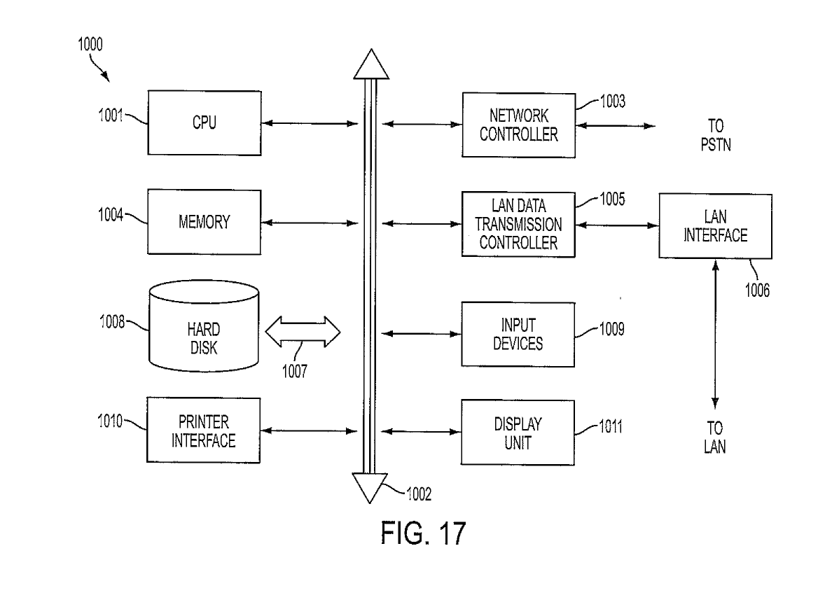

FIG. 17 shows an example of a computer system which may implement a method and system of the present disclosure. The computer system referred to generally as system 1000 may include, inter alia, a central processing unit (CPU) 1001, memory 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The memory 1004 can include random access memory (RAM), read only memory (ROM), disk drive, tape drive, etc., or a combinations thereof. The present invention can be implemented as a routine that is stored in memory 1004 and executed by the CPU 1001. As such, the computer system 1000 is a general purpose computer system that becomes a specific purpose computer system when executing the routine of the present invention.

The computer system 1000 also includes an operating system and micro instruction code. The various processes and functions described herein can either be part of the micro instruction code or part of the application program or routine (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

While the present invention has been described in detail with reference to exemplary embodiments, those skilled in the art will appreciate that various modifications and substitutions can be made thereto without departing from the spirit and scope of the invention as set forth in the appended claims. For example, elements and/or features of different exemplary embodiments may be combined with each other and/or substituted for each other within the scope of this disclosure and appended claims.

What is claimed is:

1. A method for classification of anatomical structures in digital images, comprising:
acquiring at least one digital image;
automatically detecting at least one anatomical structure in the digital image;
automatically classifying the at least one anatomical structure by applying a voxel-level segmentation to the image and a sub-volume level classification to the image.
